(19) United States
(12) Patent Application Publication
(10) Pub. No.: US 2018/0355294 A1
(43) Pub. Date: Dec. 13, 2018

(54) CONSUMER PRODUCT

(71) Applicant: The Procter & Gamble Company, Cincinnati, OH (US)

(72) Inventors: Guillaume BONNET, Brussels (BE); Nans Elian RAVIDAT, Brussels (BE); Annalise Charlotte RICHMOND, Nijlen (BE); Robby Renilde Francois KEULEERS, Lippelo (Sint Amands) (BE)

(21) Appl. No.: 16/005,906

(22) Filed: Jun. 12, 2018

(30) Foreign Application Priority Data
Jun. 13, 2017 (EP) 17175825.3
Jun. 13, 2017 (EP) 17175827.9
Jun. 13, 2017 (EP) 17175830.5
Jun. 13, 2017 (EP) 17175834.5
Apr. 11, 2018 (EP) 18166900.3
Apr. 11, 2018 (EP) 18166902.9
Apr. 11, 2018 (EP) 18166903.7
Apr. 11, 2018 (EP) 18166904.5

(51) Int. Cl. C11D 11/00; C11D 1/83; C11D 3/22; C11D 3/20; C11D 3/37

(52) U.S. Cl. CPC C11D 11/0017; C11D 1/83; C11D 17/0043; C11D 3/2082; C11D 3/3723; C11D 3/222

(57) ABSTRACT

A consumer product composed of a laundry treatment composition housed in a container, wherein the container has a spray applicator and an internal chamber housing the laundry treatment composition and the laundry treatment composition is in contact with the spray applicator and the spray applicator is capable of spraying the laundry treatment composition into the environment external to the container upon activation of the spray applicator.

### FIELD OF THE INVENTION

A consumer product comprising a container, spray applicator and a liquid laundry treatment composition.

### BACKGROUND OF THE INVENTION

Laundry wash operations and the use of laundry treatment compositions are well known.

However, for some wash operations, such as delicate garments, lightly soiled garments, or garments simply in need of a ‘refresh’ (maybe after being hung in a wardrobe for a period of time), current wash practices can be wasteful in terms of resource and environmentally unfriendly. Furthermore, consumers typically would prefer to wash these delicate items in isolation or with a very few items solely, this in order to further reduce the risk of damage due to inter-garment friction. In other words, the volume of wash composition, full washing loads and full wash cycles are not needed nor desired to achieve the desired benefit. In addition, with respect to the garments themselves, especially delicate garments, current wash process can be quite harsh on said garments.

For such applications it was found that low active or ‘mild’ spray formulations can overcome such issues. Items to be washed are sprayed with the spray formulation and then added into the wash process, for example into an automatic washing machine, without the need for any further detergent to be added. The spray application spreads the detergent composition over the fabric minimizing as such local product excess hence risk of potential local damage, and reduces the overall amount of treatment composition to be used and hence leads to reduced amount of water required in a rinse operation hence rinsing time requirement. As such short or delicate cycles or even just rinse cycles might already fulfill the need. The low active formulation provides a ‘less harsh’ treatment of the fabrics whilst still providing sufficient cleaning and/or refreshing of garments.

While overall far less detergent product will be used during the wash cycle when applying the washing process according to the invention, efficient removal of stains from the fabrics is still desired and may be impacted by the lower active levels. Therefore, the formulator will look at surfactant systems that provide excellent cleaning, for example non-soap anionic and non-ionic surfactants. However, an issue encountered with such formulations is that they provide a broad dispersed fine spray pattern when sprayed. Such broadly dispersed fine spray patterns make it difficult to spray on targeted areas of the fabrics or even wasteful spraying of the composition in areas outside of the fabric. Furthermore, such broadly dispersed spray patterns can lead to too high level of aerosolization potentially leading to ‘stinging’ (i.e. a feeling of discomfort upon inhalation). In addition, an issue encountered with such formulations is that there is also the potential for them to negatively impact the ability to spray them, especially part of the ejected liquid building up as ‘spilled foam’ at the spray exit.

Therefore, there is a need to provide a consumer product comprising a spray applicator and a low active laundry treatment composition wherein the composition can be effectively sprayed onto fabrics, preferably without impacting performance of the composition.

It was surprisingly found that the consumer product according to the present invention addressed these problems. Without wishing to be bound by theory, the careful balance of non-ionic surfactant levels to non-soap anionic surfactant levels allowed for effective and controlled spray patterns whilst still providing a composition with an effective surfactant system.

### SUMMARY OF THE INVENTION

A first aspect of the present invention is a consumer product comprising a laundry treatment composition housed in a container, wherein;
a. The container comprises a spray applicator and an internal chamber comprising the laundry treatment composition and the laundry treatment composition is in contact with the spray applicator and the spray applicator is capable of spraying the laundry treatment composition into the environment external to the container upon activation of the spray applicator;
b. The laundry treatment composition comprises at least 50%, preferably at least 60%, more preferably at least 70%, most preferably at least 80% by weight of the liquid laundry treatment composition of water; and between 1% and 15% preferably between 4% and 12%, more preferably between 5% and 10% by weight of the liquid laundry treatment composition of non-soap surfactant wherein the non-soap surfactant comprises a mixture of an anionic surfactant and a non-ionic surfactant, wherein the anionic surfactant and non-ionic surfactant are in weight ratio of from 90:10 to 50:50, preferably of from 89:11 to 60:40, more preferably of from 89:11 to 70:30, most preferably of from 89:11 to 80:20.

A second aspect of the present invention is to a process of treating at least one garment comprising the steps of;
a. Using the consumer product according to the present invention to spray at least one garment with the laundry treatment composition;
b. Optionally adding the at least one garment from step a to the drum of an automatic washing machine;
c. Optionally washing the at least one garment in the automatic washing machine wherein the drum comprises a wash liquor, wherein the wash liquor comprises water and the one or more garments and wherein the only laundry treatment composition added to the drum of the automatic washing machine is that used in step a.

### DETAILED DESCRIPTION OF THE INVENTION

### Consumer Product

The present invention discloses a consumer product comprising a liquid laundry treatment composition housed in a container.

By ‘consumer product’ we herein mean a product intended for end use by a consumer. The consumer product may be purchased as is, or may comprise at the point of purchase external packaging that is removed prior to use of the consumer product.

The container is described in more detail below.

The liquid laundry treatment composition is described in more detail below.

### The Container

The container comprises a spray applicator and an internal chamber comprising the laundry treatment composition. The liquid laundry treatment composition is in contact with the spray applicator and the spray applicator is capable of spraying the liquid laundry treatment composition into the environment external to the container upon activation of the spray applicator.

The container may be of any suitable shape or size. Those skilled in the art will be aware of suitable shapes and sizes for the container. Preferably the container is of a size that an adult can comfortably hold said container in their hand. Alternatively the container may comprise a handle to allow the user to hold said container in their hand.

The container may be made from any suitable material. The container may be manufactured from a material selected from plastic, metal, glass or a mixture thereof. The container may be made from a plastic material, preferably a polyolefin material. The container may be made from polypropylene, polystyrene, polyethylene, polyethylene terephthalate, PVC or a mixture thereof or more durable engineering plastics like Acrylonitrile Butadiene Styrene (ABS), Polycarbonates, Polyamides and the like The material used to make the container may comprise other ingredients, such as colorants, preservatives, plasticisers, UV stabilizers, oxygen, perfume and moisture barriers, recycled materials and the like.

The container may be made using any suitable process Suitable processes include but are not limited to thermoforming, injection molding, injection stretch blow molding, extrusion blow molding, tube forming from a flat laminate with a welding step, extruded tube forming.

The container may be opaque, transparent or translucent. Preferably, the container is opaque.

The container may be a pressurised container or a non-pressurised container.

The spray applicator may be any suitable spray applicator. Those skilled in the art will be aware of suitable spray applicators.

Suitable spray dispensers include hand pump (sometimes referred to as “trigger”) devices, pressurized can devices, electrostatic spray devices, etc. Preferably the spray dispenser is non-solvent propellant pressurized and the spray means are of the trigger dispensing type. The spray dispenser can be a pre-compression sprayer or an aerosol spray with a pressure control valve, both commercially available in the art. Suitable pre-compression sprayers in which a buffer mechanism to control the maximum pressure can be added include the Flairosol® spray dispenser, commercially available, manufactured and sold by Afa Dispensing Group (The Netherlands).

Preferably, upon activation of the spray applicator the laundry treatment composition is sprayed into the environment external to the container and is present as droplets having an average particle size (Dv 50%) between 100 micron and 300 micron, preferably between 100 micron and 200 micron, more preferably between 100 and 150 micron.

### Liquid Laundry Treatment Composition

The term ‘liquid laundry treatment composition’ refers to any laundry treatment composition that is a liquid and is capable of wetting and treating fabric e.g., cleaning clothing in a domestic washing machine. The liquid composition can include solids or gases in suitably subdivided form, but the liquid composition excludes forms which are non-fluid overall, such as tablets or granules.

The laundry treatment composition may be a laundry detergent composition, a laundry softening composition, a laundry care composition, a laundry scent refresher composition or a mixture thereof. Preferably the laundry treatment composition has both cleaning, refreshing and care properties, the latter including fabric softness and fabric shape and texture retention properties.

The liquid laundry treatment composition comprises at least 50%, preferably at least 60%, more preferably at least 70%, most preferably at least 80% by weight of the liquid laundry detergent composition of water. Such water levels are preferred to enable a ‘less harsh’ composition and also allow for easy spray application.

The liquid laundry treatment composition comprises between 1% and 15% preferably between 4% and 12%, more preferably between 5% and 10% by weight of the liquid laundry treatment composition of non-soap surfactant.

The non-soap surfactant is described in more detail below.

Preferably, the liquid laundry treatment composition comprises between 0.1% and 5%, preferably from 0.2% to 1%, more preferably from 0.3% to 0.7% by weight of the liquid laundry treatment composition of a polymer selected from a cationic polymer, preferably a cationic polysaccharide polymer, or a mixture thereof. Without wishing to be bound by theory, addition of the polymer is preferred as this provides even further improved spray application e.g. enabling a more condensed, controlled spray pattern. In addition, the cationic polysaccharide technology will further provide fabric conditioning benefits including softness and multi-cycle shape retention benefits.

Preferably, the cationic polymer is a cationically modified polysaccharide, preferably selected from cationic guar gums, cationic cellulosic polymers, and mixtures thereof, most preferably cationic cellulosic polymers even more preferably cationically modified hydroxyethyl cellulose, most preferably, hydroxyethyl cellulose derivatised with trimethyl ammonium substituted epoxide.

By “hydrophobically modified” we herein mean that one or more hydrophobic groups are bound to the polymer. By “cationically modified” we herein mean that one or more cationically charged groups are bound to the polymer.

The cationically modified hydroxyethyl cellulose preferably is hydroxyethyl cellulose derivatised with trimethyl ammonium substituted epoxide.

The cationic polysaccharide polymer can be synthesized in, and are commercially available in, a number of different molecular weights. In order to achieve optimal softening and care performance from the product, it is desirable that the cationic polymer used in this invention be of an appropriate molecular weight. Without wishing to be bound by theory, it is believed that polymers that are too high in mass can entrap soils and prevent them from being removed, as well as will be providing physical stability challenges especially in low viscous liquors required for spraying. The use of cationic polymers with an average molecular weight of less than about 850,000 daltons, and especially those with an average molecular weight of less than 500,000 daltons can help to minimise this effect without significantly reducing the softening performance of properly formulated products. On the other hand, polymers with a molecular weight of about 10,000 daltons or less are believed to be too small to give an effective softening benefit. Therefore the cationic polymer according to the invention preferably has a molecular weight of from about 10,000 daltons to about 850,000 daltons, preferably from about 50,000 daltons to about 750,000 daltons, more preferably from about 100,000 daltons to about 600,000 daltons, most preferably from about 200,000 daltons to about 500,000 daltons.

The cationic polymers according to the invention may also have a cationic charge density ranging from about 0.1 meq/g to about 5 meq/g, preferably from about 0.15 meq/g to about 4 meq/g, more preferably from about 0.2 meq/g to about 2.5 meq/g, even more preferably from about 0.25 meq/g to about 1.5 meq/g, most preferably from about 0.25 meq/g to about 0.7 meq/g, at the pH of intended use of the laundry composition. As used herein the “charge density” of the cationic polymers is defined as the number of cationic sites per polymer gram atomic weight (molecular weight), and can be expressed in terms of meq/gram of cationic charge. In general, adjustments of the proportions of amine or quaternary ammonium moieties in the polymer in function of the pH of the liquid laundry formulation in the case of amines, will affect the charge density. Without intending to be bound by theory, cationic polymers with a too high charge density are thought to be too sensitive to precipitate out with anionic compounds in the formulation, while cationic polymers with a too low charge density are thought to have a too low affinity to fabrics, compromising softness accordingly. Any anionic counterions can be used in association with cationic polymers. Non-limiting examples of such counterions include halides (e.g. chlorine, fluorine, bromine, iodine), sulphate and methylsulfate, preferably halides, more preferably chlorine.

The cationic polymer according to the invention might be “hydrophobically modified”. We herein mean that one or more hydrophobic groups are bound to the polymer. Without intending to be bound by theory we believe that hydrophobic modification can increase the affinity of the polymer towards the fabric. Without intending to be limiting, the one or more hydrophobic groups can be independently selected from C₁-C₃₂ preferably C₅-C₃₂ alkyl; C₁-C₃₂ preferably C₅-C₃₂ substituted alkyl, C₅-C₃₂ alkylaryl, or C₅-C₃₂ substituted alkylaryl, (poly)alkoxy C₁-C₃₂ preferably C₅-C₃₂ alkyl or (poly)alkoxy substituted C₁-C₃₂ preferably C₅-C₃₂ alkyl or mixtures thereof. Hydrophobic substitution on the polymer, preferably on the anhydroglucose rings of the cationic polymer may range from 0.01% to 5% per glucose unit, more preferably from 0.05% to 2% per glucose unit, of the polymeric material.

The cationic polysaccharide polymers according to the invention include those which are commercially available and further include materials which can be prepared by conventional chemical modification of commercially available materials. Commercially available cationic cellulose polymers according to the invention include those with the INCI name Polyquaternium 10, such as those sold under the trade names: Ucare Polymer JR 30M, JR 400, JR 125, LR 400 and LK 400 polymers; Polyquaternium 67 such as those sold under the trade name Softcat SK™, all of which are marketed by Amerchol Corporation, Edgewater N.J.; and Polyquaternium 4 such as those sold under the trade name: Celquat H200 and Celquat L-200, available from National Starch and Chemical Company, Bridgewater, N.J. Other suitable polysaccharides include hydroxyethyl cellulose or hydoxypropylcellulose quaternized with glycidyl C₁₂-C₂₂ alkyl dimethyl ammonium chloride. Examples of such polysaccharides include the polymers with the INCI names Polyquaternium 24 such as those sold under the trade name Quaternium LM 200 by Amerchol Corporation, Edgewater N.J.

Alternatively synthetic derived cationic polymers can also be used within the scope of the application.

The liquid laundry treatment composition may comprise less than 10%, preferably less than 8%, more preferably less than 5%, even more preferably less than 3%, most preferably between 0.5% and 2% by weight of the laundry treatment composition of fatty acid, neutralised fatty acid soap or a mixture thereof. Without wishing to be bound by theory, a low level of fatty acid will enable faster wash suds collapse during washing and upon rinsing, as such reducing risk of leaving detergent residues behind while maximizing active cleaning surfactant presence during the wash. A too high level of fatty acid though risks leaving calcium fatty acids deposits behind in presence of hard water and as such is not preferred.

It will be highly preferred to add cleaning performance boosting technologies into the consumer product of the invention, enabling the formulator to keep overall surfactant levels low, facilitating suds control hence residue risk accordingly. A range of possible performance boosting technologies are described below.

The laundry treatment composition may comprise less than 3%, preferably less than 2%, more preferably less than 1%, even more preferably between 0.01% and 0.5%, most preferably between 0.05% and 0.3% by weight of the laundry treatment composition of a chelant, preferably wherein the chelant is selected from amino carboxylates, amino phosphonates, polyfunctionally-substituted aromatic chelating agents and mixtures thereof, preferably selected from the group consisting of glutamic-N,N-diacetic acid (GLDA), methyl-glycine-diacetic acid (MGDA), Diethylenetriamine penta methylphosphonic acid (DTPMP), 1-hydroxyethane 1,1-diphosphonic acid (HEDP), ethylenediaminetetra-acetates (EDTA), N-hydroxyethylethylenediaminetriacetates, nitrilo-triacetates (NTA), ethylenediamine tetrapro-prionates, triethylenetetraaminehexacetates, diethylenetriaminepentaacetates, aspartic acid-N-monoacetic acid (ASMA), aspartic acid-N,N-diacetic acid (ASDA), aspartic acid-N-monopropionic acid (ASMP), iminodisuccinic acid (IDS), Imino diacetic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), alanine-N,N-diacetic acid (ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA) , taurine-N,N-diacetic acid (TUDA) and sulfomethyl-N,N-diacetic acid (SMDA), ethylenediamine disuccinate (“EDDS”), Hydroxyethyleneiminodiacetic acid, Hydroxyiminodisuccinic acid, Hydroxyethylene diaminetriacetic acid, or a mixture thereof, more preferably the chelant is selected from the group consisting of glutamic-N,N-diacetic acid (GLDA), methyl-glycine-diacetic acid (MGDA) and derivatives thereof, and/or Diethylenetriamine penta methylphosphonic acid (DTPMP), 1-hydroxyethane 1,1-diphosphonic acid (HEDP), and derivatives thereof, and mixtures thereof, most preferably Diethylenetriamine penta methylphosphonic acid (DTPMP). Without wishing to be bound by theory, the lower chelant levels are preferred to provide a less harsh laundry treatment composition while still facilitating stain removal especially bleachable stain removal.

The laundry treatment composition preferably comprise a polycarboxylate, preferably selected from the group of consisting of malonic acid, (ethyl enedioxy) diacetic acid, maleic acid, diglycolic acid, tartaric acid, tartronic acid, fumaric acid, citric acid, more preferably citric acid, wherein the citric acid is preferably present at a level of 0.1% to 5%, preferably from 0.5% to 3% most preferably from 1% to 2% by weight of the liquid treatment composition. Without wishing to be bound by theory, the lower polycarboxylate levels are preferred to provide a less harsh laundry treatment composition while still facilitating stain removal especially bleachable stain removal. In addition, they may help to protect the surfactant system against water hardness by complexing calcium and magnesium ions present in the wash liquor.

The laundry treatment composition preferably comprises between 0.01% and 3%, preferably between 0.025% and 2%, more preferably between 0.05% and 1.5% by weight of the laundry treatment composition of a soil release polymer, a polyethyleneimine preferably an alkoxylated polyethyleneimine, a zwitterionic polyamine or a mixture thereof. Preferably, the soil release polymer is selected from the group of polyester terephthalates, polyethylene glycol containing soil release polymers and a mixture thereof, and the alkoxylated polyethyleneimine is preferably an ethoxylated polyethyleneimine.

The laundry treatment composition preferably comprises less than 3%, preferably less than 2%, more preferably less than 1.5%, even more preferably between 0.01% and 1%, most preferably between 0.05% and 0.5% by weight of the laundry treatment composition of a soil release polymer, preferably selected from the group of polyester terephthalates, polyethylene glycol containing soil release polymers and a mixture thereof. Without wishing to be bound by theory, the presence of a soil release polymer is preferred to provide improved cleaning benefit whilst still providing a less harsh treatment composition.

Preferably, the laundry treatment composition comprises a polyethyleneimine, preferably an alkoxylated polyethyleneimine, more preferably an ethoxylated polyethyleneimine and wherein preferably the laundry treatment composition comprises less than 3%, preferably less than 2%, more preferably less than 1.5%, even more preferably between 0.01% and 1%, most preferably between 0.05% and 0.5% by weight of the laundry treatment composition of the polyethyleneimine, preferably ethoxylated polyethyleneimine.

The ethoxylated polyethyleneimine may have a polyethyleneimine backbone of weight average molecular weight of between 100 g/mol and 2000 g/mol, preferably between 200 g/mol and 1500 g/mol, more preferably between 300 g/mol and 1000 g/mol, even more preferably between 400 g/mol and 800 g/mol, most preferably between 500 g/mol and 700 g/mol, preferably about 600.

The ethoxylation chains within the ethoxylated polyethyleneimine may be from 200 g/mol to 2000 g/mol weight average molecular weight, preferably from 400 g/mol to 1500 g/mol weight average molecular weight, more preferably from 600 g/mol to 1000 g/mol weight average molecular weight, most preferably about 880 g/mol weight average molecular weight per ethoxylated chain.

The ethoxylation chains within the ethoxylated polyethyleneimine polymer of the present composition have on average 5 to 40, preferably 10 to 30, more preferably 15 to 25, even more preferably 18 to 22, most preferably about 20 ethoxy units per ethoxylation chain.

The ethoxylated polyethyleneimine may have a total weight average molecular weight of from 5000 g/mol to 20000 g/mol, preferably from 7500 g/mol to 17500 g/mol, more preferably from 10000 g/mol to 15000 g/mol, even more preferably from 12000 g/mol to 13000 g/mol, most preferably about 12700 g/mol.

A preferred polyethyleneimine has the general structure of formula (I):

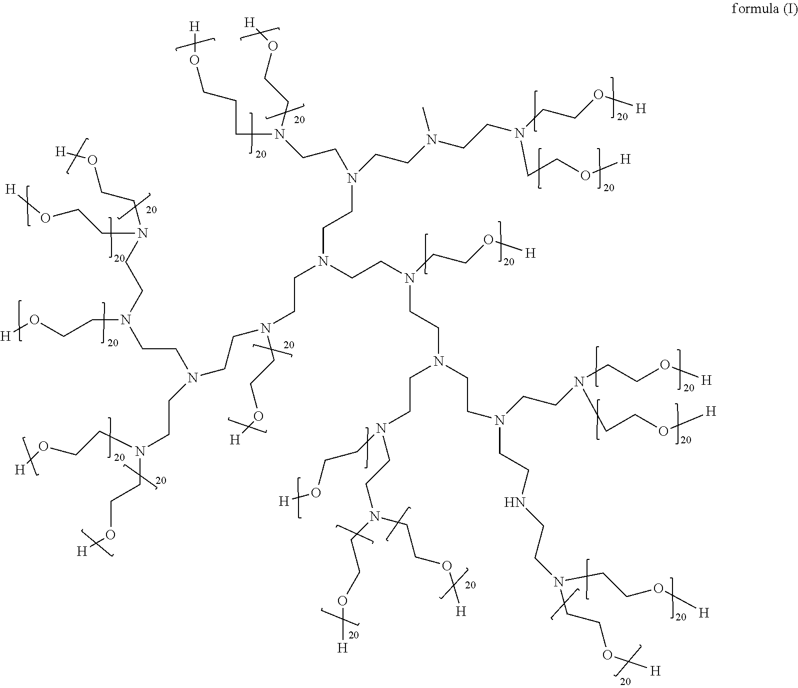

wherein the polyethyleneimine backbone has a weight average molecular weight of about 600 g/mol, n of formula (I) has an average of about 20. Each polyethoxy chain is hydrogen capped. The degree of permanent quaternization of formula (I) is about 0% of the polyethyleneimine backbone nitrogen atoms. The molecular weight of this polyethyleneimine preferably is between 10000 and 15000 g/mol, more preferably about 12700 g/mol.

The described ethoxylated polyethyleneimines can be made using techniques previously described in the art, and as such those skilled in the art would understand how to produce such compounds. These polyethyleneimines can be prepared, for example, by polymerizing ethyleneimine in the presence of a catalyst such as carbon dioxide, sodium bisulfite, sulfuric acid, hydrogen peroxide, hydrochloric acid, acetic acid, and the like, followed by an ethoxylations step.

Without wishing to be bound by theory, the presence of a polyethyleneimine is preferred to provide improved cleaning benefit whilst still providing a less harsh treatment composition.

Preferably, the laundry treatment composition comprises less than 3%, preferably less than 2%, more preferably less than 1.5%, even more preferably between 0.01% and 1%, most preferably between 0.05% and 0.5% of a zwitterionic polyamine. Particularly preferred zwitterionic polyamines are zwitterionic hexamethylene diamines according to the following formula:

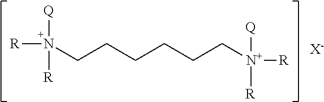

R is an anionic or partially anionic unit-capped polyalkyleneoxy unit having the formula: —(R2O)ₓR3 wherein R2 is C2-C4 linear or branched alkylene, and mixtures thereof, preferably C2 or branched C3 and mixtures thereof, even more preferably C2 (ethylene); R3 is hydrogen, an anionic unit, and mixtures thereof, in which not all R3 groups are hydrogen; x is from about 5 to about 50, preferably from about 10 to about 40, even more preferably from about 15 to about 30, most preferably from about 20 to about 25. A preferred value for x is 24, especially when R comprises entirely ethyleneoxy units. Depending upon the method by which the formulator chooses to form the alkyleneoxy units, the wider or narrower the range of alkyleneoxy units present. The formulator will recognize that when ethoxylating a zwitterionic polyamine, only an average number or statistical distribution of alkyleneoxy units will be known. x values highlighted represent average values per polyalkoxy chain. Preferably the range of alkyleneoxy units within the zwitterionic polyamine is plus or minus two units, more preferably plus or minus one unit. Most preferably each R group comprises about the same average number of alkyleneoxy units. Non-limiting examples of R3 anionic units include —(CH2)pCO2M; —(CH2)qSO3M; —(CH2)qOSO3M; —(CH2)qCH(SO2M)-CH2SO3M; —(CH2)qCH(OSO2M)CH2OSO3M; —(CH2)qCH(SO3M)CH2SO3M; —(CH2)pPO3M; —PO3M; —SO3M and mixtures thereof; wherein M is hydrogen or a water soluble cation in sufficient amount to satisfy charge balance. Preferred anionic units are —(CH2)pCO2M; —SO3M, more preferably —SO3M (sulfonate group). The indices p and q are integers from 0 to 6, preferably 0 to 2, most preferably 0. For the purposes of the present invention, all M units, can either be a hydrogen atom or a cation depending upon the form isolated by the artisan or the relative pH of the system wherein the compound is used. Non-limiting examples of preferred cations include sodium, potassium, ammonium, and mixtures thereof.

Q is a quaternizing unit selected from the group consisting of C1-C30 linear or branched alkyl, C6-C30 cycloalkyl, C7-C30 substituted or unsubstituted alkylenearyl, and mixtures thereof, preferably C1-C30 linear or branched alkyl, even more preferably C1-C10 or even C1-C5 linear or branched alkyl, most preferably methyl; the degree of quaternization preferably is more than 50%, more preferably more than 70%, even more preferably more than 90%, most preferably about 100%.

X is an anion present in sufficient amount to provide electronic neutrality, preferably a water soluble anion selected from the group consisting of chlorine, bromine, iodine, methylsulfate, and mixtures thereof, more preferably chloride. To a great degree, the counter ion X will be derived from the unit which is used to perform the quaternization. For example, if methyl chloride is used as the quaternizing agent, chlorine (chloride ion) will be the counter ion X. Bromine (bromide ion) will be the dominant counter ion in the case where benzyl bromide is the quaternizing reagent.

Preferably from about 10% to about 100%, more preferably from about 20% to about 70%, even more preferably from 30% to about 50%, most preferably from about 35% to about 45% of the R3 groups are an anionic unit, preferably a sulfonate unit, the remaining R3 units being hydrogen.

Most preferred compound is the zwitterionic hexamethylene diamine represented by the following formula:

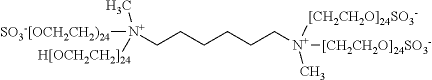

in which approximately 40% of the polyethoxy groups are sulfonated, the remaining polyethoxy groups being hydrogen capped. The degree of quaternization preferably is more than 90%, most preferably about 100%. Preferably the water soluble counter-anion is selected from the group consisting of chlorine, bromine, iodine, methylsulfate, and mixtures thereof, more preferably chloride.

Without wishing to be bound by theory, the presence of the zwitterionic polyamine is preferred to provide improved cleaning benefit whilst still providing a less harsh treatment composition.

The liquid laundry treatment composition may have a pH between 6 and 10, more preferably between 7 and 9, most preferably between 7.5 and 8.5.

Preferably, the laundry treatment composition may comprise but preferably is free of enzymes and bleaching compounds. This is preferred to allow for a less harsh treatment composition.

The laundry treatment composition may comprise adjunct materials selected from the group of dyes, opacifiers, pearlescent agents, preservatives, antioxidants, pH trimming agents, organic solvents, rheology control agents, dye transfer inhibitors, brighteners, perfume materials, silicone suds suppressors, or a mixture thereof.

The composition may be Newtonian or non-Newtonian. When Newtonian the composition preferably has a viscosity of from 1 mPa·s to 30 mPa·s, more preferably from 10 mPa·s to 25 mPa·s at 20° C., as measured using the method defined herein Alternatively, the composition of the invention can be a shear thinning fluid. Especially suitable are shear thinning compositions having a high shear viscosity at 20° C. of from 1 mPa·s to 40 mPa·s, preferably of from 10 mPa·s to 30 mPa·s at 1,000 s⁻¹, and a low shear viscosity at 20° C. of from 100 mPa·s to 1000 mPa·s, preferably of from 200 mPa·s to 500 mPa·s at 0.1 s⁻¹, as measured using the method defined herein.

### Test Method: Viscosity

The rheology profile is measured using a “TA instruments DHR1” rheometer, with a flat steel Peltier plate and a 60 mm, 2.026° cone plate geometry (TA instruments, serial number: SN960912). The flow curve procedure includes a conditioning step and a flow sweep step at 20° C. The conditioning step comprises a 10 seconds soaking step at 20° C., followed by a 10 seconds pre-shear step at 10 s⁻¹ at 20° C., followed by a 30 seconds zero shear equilibration step 20° C. The flow sweep step comprises a logarithmical shear rate increase from 0.01 s⁻¹ to 3,000 s⁻¹ at 20° C., with a 10 points per decade acquisition rate, a maximum equilibration time of 200 seconds, a sample period of 15 seconds and a tolerance of 3%.

When measuring shear thinning product compositions the high shear viscosity is defined at a shear rate of 1,000 s⁻¹, and the low shear viscosity at a shear rate of 0.1 s⁻¹. For Newtonian product compositions the shear rate at 1,000 s⁻¹ is recorded.

Preferably the laundry treatment composition comprises a polysaccharide rheology modifier or a mixture thereof, preferably a cationic polysaccharide, as described herein.

### Non-Soap Surfactant

The non-soap surfactant comprises a mixture of an anionic surfactant and a non-ionic surfactant, wherein the anionic surfactant and non-ionic surfactant are in weight ratio of from 90:10 to 50:50, preferably of from 89:11 to 60:40, more preferably of from 89:11 to 70:30, most preferably of from 89:11 to 80:20.

Preferably, the non-soap surfactant system comprises between 80% and 100% preferably between 90% and 100% or even between 95% and 100% preferably about 100% by weight of the non-soap surfactant system of the of the anionic surfactant and non-ionic surfactant mixture.

Preferably, the non-ionic surfactant is present at less than 15%, preferably between 0.1% and 10%, preferably between 0.2% and 5%, more preferably between 0.3% and 2%, most preferably between 0.5% and 1% by weight of the laundry treatment composition.

The non-ionic surfactant is preferably selected from alcohol alkoxylate nonionic surfactants preferable selected from a natural or olefin derived fatty alcohol alkoxylate, an oxo-synthesised fatty alcohol alkoxylate, Guerbet fatty alcohol alkoxylates, alkyl phenol alcohol alkoxylates or a mixture thereof.

Preferably the non-ionic surfactant is preferably an alcohol alkoxylate non-ionic surfactant, most preferably an alcohol ethoxylate non-ionic surfactant, even more preferably a mixture of alcohol ethoxylate nonionic surfactants.

Preferably, the fatty alcohol alkoxylate has an average degree of alkoxylation of between 0.5 and 10, preferably between 1 and 9, more preferably between 3 and 8, more preferably a degree of ethoxylation of between 0.5 and 10, preferably between 1 and 9, more preferably between 3 and 8 most preferably between 5 and 8 or even from about 7 to about 8.

Preferably, the fatty alcohol alkoxylate has an average alkyl chain length of between 8 and 18, preferably between 10 and 16, more preferably between 12 and 15.

More preferably the non-ionic surfactant comprises a mixture of alcohol ethoxylate surfactants, especially a mixture of a mid cut and a high cut alcohol ethoxylate with an average degree of ethoxylation of the mid cut and high cut alcohol ethoxylates of from 7 to 8. The mid cut alcohol ethoxylate is defined as having an average carbon chain length of from 12 to 14, the high cut alcohol ethoxylate is defined as having an average carbon chain length of from 14 to 15. The mid cut and high cut alcohol ethoxylate preferably are in a weight ratio of from 80:20 to 20:80, preferably 60:40 to 40:60.

Preferably, the non-soap anionic surfactant is present at less than 15%, preferably between 0.5% and 10%, more preferably between 1% and 9%, even more preferably between 2% and 8%, most preferably between 3% and 7% by weight of the liquid laundry detergent composition. The non-soap anionic surfactant may comprise a sulphate or a sulphonate anionic surfactant or a mixture thereof, preferably linear alkylbenzene sulphonate, alkyl sulphate, alkoxylated alkyl sulphate or a mixture thereof, more preferably a mixture of linear alkylbenzene sulphonate and alkoxylated alkyl sulphate.

Preferably, the alkoxylated alkyl sulphate is an ethoxylated alkyl sulphate with an average degree of ethoxylation of between 0.5 and 7, preferably between 1 and 5, more preferably between 2 and 4, most preferably about 3 and an average alkyl chain length of between 8 and 18, preferably between 10 and 16, more preferably between 12 and 14.

Preferably, the linear alkylbenzene sulphonate is a C₁₀-C₁₆ linear alkylbenzene sulphonate or a C₁₁-C₁₄ linear alkylbenzene sulphonate or a mixture thereof.

Preferably, the weight ratio of alkoxylated alkyl sulphate to linear alkylbenzene sulphonate is between 100:0 and 50:50, preferably between 90:10 and 60:40, more preferably between 85:15 and 70:30.

Without wishing to be bound by theory the non-soap surfactant system according to the invention is believed to provide the correct balance of acceptable level of foam creation and easiness of rinsing in order to prevent detergent residues on fabrics, cleaning efficacy and minimizing harshness to fabrics.

### Method of Use

A further aspect of the present invention is a process of treating at least one garment comprising the steps of;
a. Using the consumer product according to the present invention to spray at least one garment with the laundry treatment composition;
b. Optionally adding the at least one garment from step a to the drum of an automatic washing machine;
c. Optionally washing the at least one garment in the automatic washing machine wherein the drum comprises a wash liquor, wherein the wash liquor comprises water and the one or more garments and wherein the only laundry treatment composition added to the drum of the automatic washing machine is that used in step a.

### Method of Making

Any suitable method can be used to make the consumer product of the present invention. Those skilled in the art will be aware of techniques commonly known in the art to make the container and liquid treatment composition of the present invention.

### Combinations

Combination 1;

It was surprisingly found that the careful balance of non-soap anionic surfactant to nonionic surfactant in the laundry treatment composition of combination 1 provided for broader spray patterns whilst still providing a laundry treatment composition capable of being sprayed and providing laundry treatment benefits.
A. A consumer product comprising a liquid laundry treatment composition housed in a container, wherein;
   a. the container comprises a spray applicator and an internal chamber comprising the laundry treatment composition and the liquid laundry treatment composition is in contact with the spray applicator and the spray applicator is capable of spraying the liquid laundry treatment composition into the environment external to the container upon activation of the spray applicator;
   b. the liquid laundry treatment composition comprises at least 50%, preferably at least 60%, more preferably at least 70%, most preferably at least 80% by weight of the liquid laundry detergent composition of water; and between 1% and 15% preferably between 4% and 12%, more preferably between 5% and 10% by weight of the liquid laundry treatment composition of non-soap surfactant, wherein the non-soap surfactant comprises non-soap anionic surfactant and the non-soap surfactant comprises between 90% and 100%, preferably between 95% and 100%, most preferably about 100% by weight of the non-soap surfactant of the non-soap anionic surfactant,
      wherein the liquid laundry treatment composition comprises between 0.1% and 5%, preferably from 0.2% to 1%, more preferably from 0.3% to 0.7% by weight of the liquid laundry treatment composition of a polymer selected from a cationic polymer, a polysaccharide polymer, or a mixture thereof, preferably a cationic polymer.
B. The consumer product according to claim A, wherein the cationic polymer is a cationically modified polysaccharide, preferably selected from cationic guar gums, cationic cellulosic polymers, and mixtures thereof, most preferably cationic cellulosic polymers even more preferably cationically modified hydroxyethyl cellulose, most preferably, hydroxyethyl cellulose derivatised with trimethyl ammonium substituted epoxide.
C. The consumer product according to A or B wherein upon activation of the spray applicator the laundry treatment composition is sprayed into the environment external to the container and is present as droplets having an average particle size (Dv 50%) between 100 micron and 300 micron, preferably between 100 micron and 200 micron, more preferably between 100 micron and 150 micron.
D. The consumer product according to A-C wherein the non-soap anionic surfactant comprises a sulphate or a sulphonate anionic surfactant or a mixture thereof, preferably linear alkylbenzene sulphonate, alkyl sulphate, alkoxylated alkyl sulphate or a mixture thereof, more preferably a mixture of alkoxylated alkyl sulphate and linear alkylbenzene sulphonate, preferably wherein the non-soap anionic surfactant comprises linear alkylbenzene sulphonate and ethoxylated alkyl sulphate, and wherein the weight ratio of ethoxylated alkyl sulphate to linear alkylbenzene sulphonate is between 100:0 and 50:50, preferably between 90:10 and 60:40, more preferably between 85:15 and 70:30.
E. The consumer product according to D wherein the alkoxylated alkyl sulphate is an ethoxylated alkyl sulphate with an average degree of ethoxylation of between 0.5 and 7, preferably between 1 and 5, more preferably between 2 and 4, most preferably about 3 and an average alkyl chain length of between 8 and 18, preferably between 10 and 16, more preferably between 12 and 14, and the linear alkylbenzene sulphonate is a C₁₀-C₁₆ linear alkylbenzene sulphonate or a C₁₁-C₁₄ linear alkylbenzene sulphonate or a mixture thereof.
F. The consumer product according to A-E wherein the liquid laundry treatment composition comprises a non-ionic surfactant, wherein the non-ionic surfactant is an alcohol alkoxylate surfactant, preferably selected from a natural or olefin derived fatty alcohol alkoxylate, an oxo-synthesised fatty alcohol alkoxylate, Guerbet fatty alcohol alkoxylates, alkyl phenol alcohol alkoxylates or a mixture thereof, preferably wherein the liquid laundry treatment composition comprises less than 10%, preferably less than 5%, by weight of the non-soap surfactant of the nonionic surfactant.
G. The consumer product according to F, wherein the fatty alcohol alkoxylate has an average degree of alkoxylation of between 0.5 and 10, preferably between 1 and 9, more preferably between 3 and 8, more preferably a degree of ethoxylation of between 0.5 and 10, preferably between 1 and 9, more preferably between 3 and 8, most preferably between 5 and 8 or even from about 7 to about 8, and wherein the fatty alcohol alkoxylate preferably has an average alkyl chain length of between 8 and 18, preferably between 10 and 16, more preferably between 12 and 15.
H. The consumer product according to A-G wherein the liquid laundry treatment composition comprises less than 10%, preferably less than 8%, more preferably less than 5%, even more preferably less than 3%, most preferably between 0.5% and 2% by weight of the laundry treatment composition of fatty acid, neutralised fatty acid soap or a mixture thereof.
I. The consumer product according to A-H wherein the laundry treatment composition comprises less than 3%, preferably less than 2%, more preferably less than 1%, even more preferably between 0.01% and 0.5%, most preferably between 0.05% and 0.3% by weight of the laundry treatment composition of a chelant, preferably wherein the chelant is selected from amino carboxylates, amino phosphonates, polyfunctionally-substituted aromatic chelating agents and mixtures thereof, preferably selected from the group consisting of glutamic-N,N-diacetic acid (GLDA), methyl-glycine-diacetic acid (MGDA), Diethylenetriamine penta methylphosphonic acid (DTPMP), 1-hydroxyethane 1,1-diphosphonic acid (HEDP), ethylenediaminetetra-acetates (EDTA), N-hydroxyethylethylenediaminetriacetates, nitrilo-triacetates (NTA), ethylenediamine tetrapro-prionates, triethylenetetraaminehexacetates, diethylenetriaminepentaacetates, aspartic acid-N-monoacetic acid (ASMA), aspartic acid-N,N-diacetic acid (ASDA), aspartic acid-N-monopropionic acid (ASMP), iminodisuccinic acid (IDS), Imino diacetic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), alanine-N,N-diacetic acid (ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA), ethylenediamine disuccinate (“EDDS”), Hydroxyethyleneiminodiacetic acid, Hydroxyiminodisuccinic acid, Hydroxyethylene diaminetriacetic acid, or a mixture thereof, more preferably the chelant is selected from the group consisting of glutamic-N,N-diacetic acid (GLDA), methyl-glycine-diacetic acid (MGDA) and derivatives thereof, and/or Diethylenetriamine penta methylphosphonic acid (DTPMP), 1-hydroxyethane 1,1-diphosphonic acid (HEDP), and derivatives thereof, and mixtures thereof, most preferably Diethylenetriamine penta methylphosphonic acid (DTPMP).
J. The consumer product according to A-I wherein the laundry treatment composition comprises a polycarboxylate, preferably selected from the group of consisting of malonic acid, (ethyl enedioxy) diacetic acid, maleic acid, diglycolic acid, tartaric acid, tartronic acid, fumaric acid, citric acid, more preferably citric acid, wherein the citric acid is preferably present at a level of 0.1% to 5%, preferably from 0.5% to 3% most preferably from 1% to 2% by weight of the liquid treatment composition.
K. The consumer product according to A-J wherein the laundry treatment composition comprises between 0.01% and 3%, preferably between 0.025% and 2%, more preferably between 0.05% and 1.5% by weight of the laundry treatment composition of a soil release polymer, a polyethyleneimine preferably an alkoxylated polyethyleneimine, a zwitterionic polyamine or a mixture thereof, preferably wherein the soil release polymer is selected from the group of polyester terephthalates, polyethylene glycol containing soil release polymers and a mixture thereof, and the alkoxylated polyethyleneimine is preferably an ethoxylated polyethyleneimine.
L. The consumer product according to A-K wherein the liquid laundry treatment composition has a pH between 6 and 10, more preferably between 7 and 9, most preferably between 7.5 and 8.5.
M. The consumer product according A-L wherein the laundry treatment composition may comprise but preferably is free of enzymes and bleaching compounds.
N. A process of treating at least one garment comprising the steps of;
   a. Using the consumer product according to A-M to spray at least one garment with the laundry treatment composition;
   b. Optionally adding the at least one garment from step a to the drum of an automatic washing machine;
   c. Optionally washing the at least one garment in the automatic washing machine wherein the drum comprises a wash liquor, wherein the wash liquor comprises water and the one or more garments and wherein the only laundry treatment composition added to the drum of the automatic washing machine is that used in step a.

### Combination 2;

Without wishing to be bound by theory, the careful balance of non-soap surfactant and cationic polysaccharide according to combination 2 allowed for effective and controlled spray patterns whilst still providing a composition with an effective surfactant system.
O. A consumer product comprising a liquid laundry treatment composition housed in a container, wherein;
   a. the container comprises a spray applicator and an internal chamber comprising the laundry treatment composition and the laundry treatment composition is in contact with the spray applicator and the spray applicator is capable of spraying the laundry treatment composition into the environment external to the container upon activation of the spray applicator;
   b. the liquid laundry treatment composition comprises at least 50%, preferably at least 60%, more preferably at least 70%, most preferably at least 80% by weight of the liquid laundry treatment composition of water; and
      between 1% and 15%, preferably between 4% and 12%, more preferably between 5% and 10% by weight of the liquid laundry treatment composition of a non-soap surfactant, preferably wherein the non-soap surfactant comprises an anionic surfactant, a non-ionic surfactant, or a mixture thereof; and
      between 0.1% and 5%, preferably from 0.2% to 1%, more preferably from 0.3% to 0.7% by weight of the liquid laundry treatment composition of a polymer selected from a cationic polysaccharide.
P. The consumer product according to O wherein upon activation of the spray applicator the liquid laundry treatment composition is sprayed into the environment external to the container and is present as droplets having an average particle size (Dv 50%) between 100 micron and 300 micron, preferably between 100 micron and 200 micron, more preferably between 100 micron and 150 micron.
Q. The consumer product according to O-P wherein the liquid laundry treatment composition comprises less than 15%, preferably between 0.5% and 10%, more preferably between 1% and 9%, even more preferably between 2% and 8%, most preferably between 3% and 7% by weight of the liquid laundry treatment composition of the non-soap anionic surfactant.
R. The consumer product according to O-Q wherein the anionic surfactant comprises a sulphate or a sulphonate anionic surfactant or a mixture thereof, preferably linear alkylbenzene sulphonate, alkyl sulphate, alkoxylated alkyl sulphate or a mixture thereof, more preferably a mixture of alkoxylated alkyl sulphate and linear alkylbenzene sulphonate,
   wherein preferably the alkoxylated alkyl sulphate is an ethoxylated alkyl sulphate with an average degree of ethoxylation of between 0.5 and 7, preferably between 1 and 5, more preferably between 2 and 4, most preferably about 3 and an average alkyl chain length of between 8 and 18, preferably between 10 and 16, more preferably between 12 and 14.
S. The consumer product according to O-R wherein the non-ionic surfactant is an alcohol alkoxylate surfactant, preferably selected from a natural or olefin derived fatty alcohol alkoxylate, an oxo-synthesised fatty alcohol alkoxylate, Guerbet fatty alcohol alkoxylates, alkyl phenol alcohol alkoxylates or a mixture thereof.
T. The consumer product according to O-S wherein the liquid laundry treatment composition comprises less than 15%, preferably between 0.1% and 10%, preferably between 0.2% and 5%, more preferably between 0.3% and 2%, most preferably between 0.5% and 1% by weight of the liquid laundry treatment composition of a nonionic surfactant, preferably an alcohol alkoxylate non-ionic surfactant, most preferably an alcohol ethoxylate non-ionic surfactant;
   wherein the fatty alcohol alkoxylate has an average degree of alkoxylation of between 0.5 and 10, preferably between 1 and 9, more preferably between 3 and 8, more preferably a degree of ethoxylation of between 0.5 and 10, preferably between 1 and 9, more preferably between 3 and 8, even more preferably between 5 and 8 or most preferably from 7 to 8, and wherein the fatty alcohol alkoxylate preferably has an average alkyl chain length of between 8 and 18, preferably between 10 and 16, more preferably between 12 and 15.
U. The consumer product according to O-T wherein the non-soap surfactant comprises between 80% and 100% preferably between 90% and 100% or even between 95% and 100% preferably about 100% by weight of the non-soap surfactant of the anionic surfactant, non-ionic surfactant or a mixture thereof, preferably a mixture thereof.
V. The consumer product according to O-U wherein the laundry treatment composition comprises less than 10%, preferably less than 8%, more preferably less than 5%, even more preferably less than 3%, or most preferably between 0.5% and 2% by weight of the laundry treatment composition of fatty acid, neutralised fatty acid soap or a mixture thereof.
W. The consumer product according to O-V wherein the cationic polysaccharide is selected from cationic guar gums, cationic cellulosic polymers, and mixtures thereof, most preferably cationic cellulosic polymers, even more preferably cationically modified hydroxyethyl cellulose, most preferably, hydroxyethyl cellulose derivatised with trimethyl ammonium substituted epoxide.
X. The consumer product according to O-W wherein the laundry treatment composition comprises less than 3%, preferably less than 2%, more preferably less than 1%, even more preferably between 0.01% and 0.5%, most preferably between 0.05% and 0.3% by weight of the laundry treatment composition of a chelant, preferably wherein the chelant is selected from amino carboxylates, amino phosphonates, polyfunctionally-substituted aromatic chelating agents and mixtures thereof, preferably selected from the group consisting of glutamic-N,N-diacetic acid (GLDA), methyl-glycine-diacetic acid (MGDA), Diethylenetriamine penta methylphosphonic acid (DTPMP), 1-hydroxyethane 1,1-diphosphonic acid (HEDP), ethylenediaminetetra-acetates (EDTA), N-hydroxyethylethylenediaminetriacetates, nitrilo-triacetates (NTA), ethylenediamine tetrapro-prionates, triethylenetetraaminehexacetates, diethylenetriaminepentaacetates, aspartic acid-N-monoacetic acid (ASMA), aspartic acid-N,N-diacetic acid (ASDA), aspartic acid-N-monopropionic acid (ASMP), iminodisuccinic acid (IDS), Imino diacetic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), alanine-N,N-diacetic acid (ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA), ethylenediamine disuccinate (“EDDS”), Hydroxyethyleneiminodiacetic acid, Hydroxyiminodisuccinic acid, Hydroxyethylene diaminetriacetic acid, or a mixture thereof, more preferably the chelant is selected from the group consisting of glutamic-N,N-diacetic acid (GLDA), methyl-glycine-diacetic acid (MGDA) and derivatives thereof, and/or Diethylenetriamine penta methylphosphonic acid (DTPMP), 1-hydroxyethane 1,1-diphosphonic acid (HEDP), and derivatives thereof, and mixtures thereof, most preferably Diethylenetriamine penta methylphosphonic acid (DTPMP).
Y. The consumer product according to O-X wherein the laundry treatment composition comprises a polycarboxylate, preferably selected from the group of consisting of malonic acid, (ethylenedioxy) diacetic acid, maleic acid, diglycolic acid, tartaric acid, tartronic acid, fumaric acid, citric acid, more preferably citric acid, wherein the citric acid is preferably present at a level of 0.1% to 5%, preferably from 0.5% to 3% most preferably from 1% to 2% by weight of the liquid treatment composition.
Z. The consumer product according to O-Y wherein the laundry treatment composition comprises between 0.01% and 3%, preferably between 0.025% and 2%, more preferably between 0.05% and 1.5% by weight of the laundry treatment composition of a soil release polymer, a polyethyleneimine preferably an alkoxylated polyethyleneimine, a zwitterionic polyamine or a mixture thereof, preferably wherein the soil release polymer is selected from the group of polyester terephthalates, polyethylene glycol containing soil release polymers and a mixture thereof, and the alkoxylated polyethyleneimine is preferably an ethoxylated polyethyleneimine.
AA. The consumer product according to O-Z wherein the liquid laundry treatment composition has a pH between 6 and 10, more preferably between 7 and 9, most preferably between 7.5 and 8.5.
BB. The consumer product according to O-AA wherein the laundry treatment composition may comprise but preferably is free of enzymes and bleaching compounds.
CC. A process of treating at least one garment comprising the steps of;
   a. Using the consumer product according to O-CC to spray at least one garment with the laundry treatment composition;
   b. Optionally adding the at least one garment from step a to the drum of an automatic washing machine;
   c. Optionally washing the at least one garment in the automatic washing machine wherein the drum comprises a wash liquor, wherein the wash liquor comprises water and the one or more garments and wherein the only laundry treatment composition added to the drum of the automatic washing machine is that used in step a.

### Combination 3;

Without wishing to be bound by theory, the careful balance of non-ionic surfactant levels to non-soap anionic surfactant levels in combination 3 allowed for effective and controlled spray patterns whilst still providing a composition with an effective surfactant system.
DD. A consumer product comprising a laundry treatment composition housed in a container, wherein;
   a. The container comprises a spray applicator and an internal chamber comprising the laundry treatment composition and the laundry treatment composition is in contact with the spray applicator and the spray applicator is capable of spraying the laundry treatment composition into the environment external to the container upon activation of the spray applicator;
   b. the liquid laundry treatment composition comprises at least 50% preferably at least 60%, more preferably at least 70%, most preferably at least 80% by weight of the liquid laundry detergent composition of water; and between 1% and 15% preferably between 4% and 12%, more preferably between 5% and 10% by weight of the liquid laundry detergent composition of non-soap surfactant, wherein the non-soap surfactant comprises non-ionic surfactant and the non-soap surfactant comprises between 50% and 100%, preferably between 70% and 100%, more preferably between 80% and 100%, even more preferably between 90% and 100%, most preferably about 100% by weight of the non-soap surfactant of the non-ionic surfactant.
EE. The consumer product according to DD wherein the liquid laundry treatment composition comprises between 0.1% and 5%, preferably from 0.2% to 1%, more preferably from 0.3% to 0.7% by weight of the liquid laundry treatment composition of a polymer selected from a cationic polymer, a polysaccharide polymer, or a mixture thereof, preferably a cationic polymer; wherein
   preferably, the cationic polymer, is a cationically modified polysaccharide, preferably selected from cationic guar gums, cationic cellulosic polymers, and mixtures thereof, most preferably cationic cellulosic polymers even more preferably cationically modified hydroxyethyl cellulose, most preferably, hydroxyethyl cellulose derivatised with trimethyl ammonium substituted epoxide.
FF. The consumer product according to DD or EE wherein upon activation of the spray applicator the laundry treatment composition is sprayed into the environment external to the container and is present as droplets having an average particle size (Dv 50%) between 100 micron and 300 micron, preferably between 100 micron and 200 micron, more preferably between 100 micron and 150 micron.
GG. The consumer product according to DD-FF wherein the non-ionic surfactant is an alcohol alkoxylate surfactant, preferably selected from a natural or olefin derived fatty alcohol alkoxylate, an oxo-synthesised fatty alcohol alkoxylate, Guerbet fatty alcohol alkoxylates, alkyl phenol alcohol alkoxylates or a mixture thereof.
HH. The consumer product according GG, wherein the alcohol alkoxylate, non-ionic surfactant or a mixture thereof has an average degree of alkoxylation of between 0.5 and 10, preferably between 1 and 9, more preferably between 3 and 8, more preferably a degree of ethoxylation of between 0.5 and 10, preferably between 1 and 9, more preferably between 3 and 8, most preferably between 5 and 8 or even from about 7 to about 8, preferably wherein the alcohol alkoxylate, non-ionic surfactant or a mixture thereof has an average alkyl chain length of between 8 and 18, preferably between 10 and 16, more preferably between 12 and 15.
II. The consumer product according to DD-HH wherein the liquid laundry treatment composition comprises a non-soap anionic surfactant, preferably wherein the non-soap surfactant comprises less than 50%, preferably less than 30%, more preferably less than 20%, even more preferably less than 10%, most preferably less than 5% by weight of the non-soap surfactant of the non-soap anionic surfactant.
JJ. The consumer product according to II wherein the anionic surfactant comprises a sulphate or a sulphonate anionic surfactant or a mixture thereof, preferably linear alkylbenzene sulphonate, alkyl sulphate, alkoxylated alkyl sulphate or a mixture thereof, more preferably a mixture of alkoxylated alkyl sulphate and linear alkylbenzene sulphonate, even more preferably wherein the alkoxylated alkyl sulphate is an ethoxylated alkyl sulphate, preferably wherein the ethoxylated alkyl sulphate has an average degree of ethoxylation between 1 and 5, preferably between 2 and 4, most preferably 3, and an average alkyl chain length of between 8 and 18, more preferably between 10 and 16, most preferably between 12 and 14.
KK. The consumer product according to DD-JJ wherein the laundry treatment composition comprises less than 10%, preferably less than 8%, more preferably less than 5%, even more preferably less than 3%, most preferably between 0.5% and 2% by weight of the laundry treatment composition of fatty acid, neutralised fatty acid soap or a mixture thereof.
LL. The consumer product according to DD-KK wherein the laundry treatment composition comprises less than 3%, preferably less than 2%, more preferably less than 1%, even more preferably between 0.01% and 0.5%, most preferably between 0.05% and 0.3% by weight of the laundry treatment composition of a chelant, preferably wherein the chelant is selected from amino carboxylates, amino phosphonates, polyfunctionally-substituted aromatic chelating agents and mixtures thereof, preferably selected from the group consisting of glutamic-N,N-diacetic acid (GLDA), methyl-glycine-diacetic acid (MGDA), Diethylenetriamine penta methylphosphonic acid (DTPMP), 1-hydroxyethane 1,1-diphosphonic acid (HEDP), ethylenediaminetetra-acetates (EDTA), N-hydroxyethylethylenediaminetriacetates, nitrilo-triacetates (NTA), ethylenediamine tetrapro-prionates, triethylenetetraaminehexacetates, diethylenetriaminepentaacetates, aspartic acid-N-monoacetic acid (ASMA), aspartic acid-N,N-diacetic acid (ASDA), aspartic acid-N-monopropionic acid (ASMP), iminodisuccinic acid (IDS), Imino diacetic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), alanine-N,N-diacetic acid (ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA), ethylenediamine disuccinate (“EDDS”), Hydroxyethyleneiminodiacetic acid, Hydroxyiminodisuccinic acid, Hydroxyethylene diaminetriacetic acid, or a mixture thereof, more preferably the chelant is selected from the group consisting of glutamic-N,N-diacetic acid (GLDA), methyl-glycine-diacetic acid (MGDA) and derivatives thereof, and/or Diethylenetriamine penta methylphosphonic acid (DTPMP), 1-hydroxyethane 1,1-diphosphonic acid (HEDP), and derivatives thereof, and mixtures thereof, most preferably Diethylenetriamine penta methylphosphonic acid (DTPMP).
MM. The consumer product according to DD-LL wherein the laundry treatment composition comprises a polycarboxylate, preferably selected from the group of consisting of malonic acid, (ethyl enedioxy) diacetic acid, maleic acid, diglycolic acid, tartaric acid, tartronic acid, fumaric acid, citric acid, more preferably citric acid, wherein the citric acid is preferably present at a level of 0.1% to 5%, preferably from 0.5% to 3% most preferably from 1% to 2% by weight of the liquid treatment composition.
NN. The consumer product according to DD-MM wherein the laundry treatment composition comprises between 0.01% and 3%, preferably between 0.025% and 2%, more preferably between 0.05% and 1.5% by weight of the laundry treatment composition of a soil release polymer, a polyethyleneimine preferably an alkoxylated polyethyleneimine, a zwitterionic polyamine or a mixture thereof, preferably wherein the soil release polymer is selected from the group of polyester terephthalates, polyethylene glycol containing soil release polymers and a mixture thereof, and the alkoxylated polyethyleneimine is preferably an ethoxylated polyethyleneimine.
OO. The consumer product according to DD-NN wherein the liquid laundry treatment composition has a pH between 6 and 10, more preferably between 7 and 9, most preferably between 7.5 and 8.5.
PP. The consumer product according to DD-OO wherein the laundry treatment composition may comprise but preferably is free of enzymes and bleaching compounds.
QQ. A process of treating at least one garment comprising the steps of;
   a. Using the consumer product according to DD-PP to spray at least one garment with the laundry treatment composition;
   b. Optionally adding the at least one garment from step a to the drum of an automatic washing machine;
   c. Optionally washing the at least one garment in the automatic washing machine wherein the drum comprises a wash liquor, wherein the wash liquor comprises water and the one or more garments and wherein the only laundry treatment composition added to the drum of the automatic washing machine is that used in step a.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### EXAMPLES

The impact of a mixed surfactant system according to the invention (Example 1), compared to individual type of surfactant systems outside the scope of the invention (Comparative example 1: full anionic surfactant system) has been assessed on its ability to control spray dispersion.

### Formula Compositions:

| | | Comparative |
|---|---|---|
| Wt % (100% active) | Example 1 | example 1 |
| Ethanol | 0.81 | 0.81 |
| 1,2 Propylene glycol | 0.37 | 0.37 |
| Citric Acid | 1.47 | 1.47 |
| HLAS | 1.09 | 1.25 |
| C24 EO7 nonionic surfactant | 0.40 | — |
| C45 EO7 nonionic surfactant | 0.39 | — |
| Na-salt of Diethylene | 0.11 | 0.11 |
| triamine | | |
| pentamethylphosphonic acid | | |
| (DTPMP)-chelant | | |
| Palm Kernel Fatty Acid | 1.88 | 1.88 |
| zwitterionic polyamine | 0.14 | 0.14 |
| (Lutensit Z96 ex BASF) | | |
| C24 AE3S anionic surfactant | 4.31 | 4.95 |
| FWA36 | 0.001 | 0.001 |
| Perfume | 0.500 | 0.500 |
| Water and minors (silicone | Balance | Balance |
| suds suppressor-preservative- | | |
| NaOH for pH-trimming) | | |
| pH | 8.1 | 8.1 |

### Spray Bottles:

Flash Clean & Shine All Purpose Cleaning Spray (Lemon) ex Procter & Gamble Company, as commercially available in the UK on January 2017.

### Test Design:

A spray bottle is placed on a bench at a distance of 20cm between the front exit of the nozzle and the spraying target. The spraying target is a vertical positioned plastic slide used for laser printing (003R98203—XEROX A3 TRANSPARENCY—PET material), collecting one single spray of detergent composition. An image of the spray pattern is achieved through scanning the sprayed-on plastic slide using a Xerox A3 scanner (Xerox® DocuMate® 4830). The image is consequently analyzed for number of liquid particles (at a lower size threshold for smaller particles of 0.01 mm), using publicly available ImageJ Java-based image analysis software developed at the National Institutes of Health. 2 identical spray bottles were used to test the example 1 versus the comparative example formulation. The average values of two replicates are reported.

### Test Results:

The below table summarizes the analyzed spray patterns of the mixed anionic nonionic surfactant system according the scope of the invention (Example 1), compared to a full anionic surfactant system outside the scope to the invention (Comparative example 1). It can clearly be seen that a mixed surfactant system (Example 1) leads to a less broadly dispersed hence more controlled spray pattern compared to the full anionic (Comparative example 1) formulation, as supported by a lower number of sprayed particles despite equal sprayed volume.

| # of sprayed | | Comparative |
|---|---|---|
| particles | Example 1 | Example 1 |
| Spray bottle | 1497 | 1740 |

What is claimed is:

1. A consumer product comprising a laundry treatment composition housed in a container, wherein;
a. The container comprises a spray applicator and an internal chamber comprising the laundry treatment composition and the laundry treatment composition is in contact with the spray applicator and the spray applicator is capable of spraying the laundry treatment composition into the environment external to the container upon activation of the spray applicator;
b. The laundry treatment composition comprises at least about 50%, by weight of the liquid laundry treatment composition of non-soap surfactant wherein the non-soap surfactant comprises a mixture of an anionic surfactant and a non-ionic surfactant, wherein the anionic surfactant and non-ionic surfactant are in weight ratio of from about 90:10 to about 50:50,
wherein the liquid laundry treatment composition comprises between about 0.1% and about 5%, by weight of the liquid laundry treatment composition of a polymer selected from a cationic polymer.

2. The consumer product according to claim 1 wherein the cationic polymer is a cationically modified polysaccharide.

3. The consumer product according to claim 1 wherein the cationic polymer is selected from cationic guar gums, cationic cellulosic polymers, and mixtures thereof.

4. The consumer product according to claim 3 wherein the cationic polymer is hydroxyethyl cellulose derivatised with trimethyl ammonium substituted epoxide.

5. The consumer product according to claim 1 wherein upon activation of the spray applicator the laundry treatment composition is sprayed into the environment external to the container and is present as droplets having an average particle size (Dv 50%) between about 100 micron and about 300 micron.

6. The consumer product according to claim 1 wherein the non-soap surfactant system comprises between about 80% and about 100% by weight of the non-soap surfactant system of the of the anionic surfactant and non-ionic surfactant mixture.

7. The consumer product according to claim 1 wherein the non-ionic surfactant is present at less than about 15%, by weight of the laundry treatment composition.

8. The consumer product according to claim 1 wherein the non-ionic surfactant is an alcohol alkoxylate non-ionic surfactant.

9. The consumer product according to claim 8, wherein the alcohol alkoxylate non-ionic surfactant is a fatty alcohol alkoxylate having an average degree of alkoxylation of between about 0.5 and about 10, and a degree of ethoxylation of between about 0.5 and about 10.

10. The consumer product according to claim 1 wherein the non-soap anionic surfactant is present at less than about 15% by weight of the liquid laundry detergent composition.

11. The consumer product according to claim 10 wherein the non-soap anionic surfactant comprises a sulphate or a sulphonate anionic surfactant or a mixture thereof.

12. The consumer product according to claim 11 wherein the non-soap anionic surfactant comprises alkoxylated alkyl sulphate and linear alkylbenzene sulphonate and wherein the weight ratio of alkoxylated alkyl sulphate to linear alkylbenzene sulphonate is between about 100:0 and about 50:50.

13. The consumer product according to claim 1 wherein the laundry treatment composition comprises less than about 10% by weight of the laundry treatment composition of fatty acid, neutralised fatty acid soap or a mixture thereof.

14. The consumer product according to claim 1 wherein the laundry treatment composition comprises less than 3% by weight of the laundry treatment composition of a chelant, wherein the chelant is selected from amino carboxylates, amino phosphonates, polyfunctionally-substituted aromatic chelating agents and mixtures thereof, preferably selected from the group consisting of glutamic-N,N-diacetic acid (GLDA), methyl-glycine-diacetic acid (MGDA), Diethylenetriamine penta methylphosphonic acid (DTPMP), 1-hydroxyethane 1,1-diphosphonic acid (HEDP), ethylenediaminetetra-acetates (EDTA), N-hydroxyethylethylenediaminetriacetates, nitrilo-triacetates (NTA), ethylenediamine tetrapro-prionates, triethylenetetraaminehexacetates, diethylenetriaminepentaacetates, aspartic acid-N-monoacetic acid (ASMA), aspartic acid-N,N-diacetic acid (ASDA), aspartic acid-N-monopropionic acid (ASMP), iminodisuccinic acid (IDS), Imino diacetic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), alanine-N,N-diacetic acid (ALDA) , serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA), ethylenediamine disuccinate (“EDDS”), Hydroxyethyleneiminodiacetic acid, Hydroxyiminodisuccinic acid, Hydroxyethylene diaminetriacetic acid, or a mixture thereof.

15. The consumer product according to claim 1 wherein the laundry treatment composition comprises a polycarboxylate, selected from the group consisting of malonic acid, (ethyl enedioxy) diacetic acid, maleic acid, diglycolic acid, tartaric acid, tartronic acid, fumaric acid, citric acid or a mixture thereof.

16. The consumer product according to claim 1 wherein the laundry treatment composition comprises between about 0.01% and about 3% by weight of the laundry treatment composition of a soil release polymer, a polyethyleneimine, a zwitterionic polyamine or a mixture thereof.

17. The consumer product according to claim 1 wherein the liquid laundry treatment composition has a pH between about 6 and about 10.

18. The consumer product according to claim 1 wherein the laundry treatment composition may comprise enzymes and bleaching compounds.

19. The consumer product according to claim 18 wherein the laundry treatment composition is free of enzymes and bleaching compounds.

20. A process of treating at least one garment comprising the steps of;
a. Using the consumer product according to claim 1 to spray at least one garment with the laundry treatment composition;
b. Optionally adding the at least one garment from step a to the drum of an automatic washing machine;
c. Optionally washing the at least one garment in the automatic washing machine wherein the drum comprises a wash liquor, wherein the wash liquor comprises water and the one or more garments and wherein the only laundry treatment composition added to the drum of the automatic washing machine is that used in step a.
